(19) United States
(12) Patent Application Publication
(10) Pub. No.: US 2024/0240406 A1
(43) Pub. Date: Jul. 18, 2024

(54) MULTIPLY CONTAINERBOARD FOR USE IN CORRUGATED BOARD

(71) Applicant: Stora Enso OYJ, Helsinki (FI)

(72) Inventors: Isto Heiskanen, Imatra (FI); Jukka Kankkunen, Imatra (FI)

(73) Assignee: Stora Enso OYJ, Helsinki (FI)

(21) Appl. No.: 18/559,422

(22) PCT Filed: May 13, 2022
(86) PCT No.: PCT/IB2022/054474

§ 371 Date: Nov. 7, 2023

(30) Foreign Application Priority Data
May 17, 2021 (SE) 2150624-1

(51) Int. Cl. D21H 27/10; D21H 11/04; D21H 11/06; D21H 17/25; D21H 17/28; D21H 21/10; D21H 21/16; D21H 21/18; D21H 27/40

(52) U.S. Cl. CPC D21H 27/10; D21H 11/04; D21H 11/06; D21H 17/25; D21H 17/28; D21H 21/10; D21H 21/16; D21H 21/18; D21H 27/40

(57) ABSTRACT

The present invention relates to a multiply containerboard for use in corrugated board, said multiply containerboard comprising: a first outer ply comprising a strength enhancement agent, a second outer ply comprising a strength enhancement agent, and an interfacial layer joining said first and second outer ply, wherein each of said first and second outer ply comprise at least 50 wt % neutral sulfite semi chemical (NSSC) pulp based on dry weight, and wherein said interfacial layer comprises a strength enhancement agent in an amount of 0.5-20 gsm wherein the amount of strength enhancement agent in the interfacial layer is higher, preferably at least twice as high as the concentration of the strength enhancement agent in each of the first and second outer ply.

### TECHNICAL FIELD

The present invention relates to a multiply containerboard for use in corrugated board.

### BACKGROUND

Corrugated board (sometimes referred to as corrugated cardboard or corrugated fiberboard) is a packaging material which can be converted to different types of packaging solutions. Corrugated board is a fiber based material made from cellulose fibers. The fibers can be virgin fibers or recycled fibers, such as fibers from used corrugated cardboard or other materials.

The corrugated board comprises at least one corrugated medium (fluting) and at least one non-corrugated medium (liner or linerboard) glued onto a surface of the corrugated medium. For example, the corrugated board may consist of a layer of fluting glued between two layers of liner to form a sandwich structure. The sandwich structure can be formed in different ways such as in single, double, and triple walls as described, e.g., in Kirwan M., J., Paper and Paperboard. Packaging Technology, Blackwell Publishing 2005.

One difficulty when producing corrugated board is the adhesion of the liner to the fluting. Too low adhesion causes delamination and addition of too much adhesive to ensure that the adhesion is sufficient can cause washboarding and curl of the corrugated board. It is important that the adsorption of the added glue into the liner and/or corrugated medium is optimal. If the adhesive is not adsorbed by the fluting/liner delamination will occur and the same will happen if it is adsorbed too much into the fluting/liner.

There are different kinds of corrugated board qualities, and these may comprise different types of liners and corrugated media. Containerboard (also known as CCM or corrugated case material) is a type of paperboard specially manufactured for the production of corrugated board. It includes both linerboard and corrugating medium (or fluting), the two types of paper that make up corrugated board. Since containerboard is made mainly out of natural unbleached wood fibers, it is generally brown, although its shade may vary depending on the type of wood, pulping process, recycling rate and impurities content.

Examples of different types of liners are kraftliner and testliner. Kraftliner is typically produced from kraft pulp that can be bleached or unbleached and may comprise one or more layers/plies wherein the top layer/ply is often optimized to provide a good printing surface and good moisture resistance. Testliner is mainly produced from recycled corrugated board and is commonly manufactured in two layers/plies. Due to the presence of recycled fibers, testliner may typically have lower mechanical strength, particularly lower burst strength, than kraftliner. Kraftliner is frequently used in packaging boxes with higher demands on strength properties.

Fluting is formed from paper or paperboard which has been corrugated using heat, moisture and pressure using a corrugator.

Fluting is often prepared from neutral sulfite semi chemical (NSSC) pulp. NSSC pulp, which is normally made from hardwood species, is noted for exceptional stiffness and high rigidity making it suitable for use in fluting. Neutral Sulfite Semi-Chemical (NSSC) pulping is an old process that it is well known in the field of paper pulping. One of the reasons for using NSSC pulping is the high yield, typically above 60%. In NSSC pulping, the cooking liquor comprises sulfite, such as Na₂SO₃ or (NH₄)₂SO₃ and a base, such as NaOH or Na₂CO₃. “Neutral” means that the pH of the NSSC cooking liquor is generally between 6 and 10. The pulp can be cooked in a batch or continuous cooker. Normally, the cooking time is between 5 minutes and 3 hours and the cooking temperature is 160-200° C. The NSSC pulp comprises comparatively high amounts of residual lignin, such as 15-20%, which makes the NSSC pulp stiff. The Kappa number of the NSSC pulp is typically above 70. The NSSC pulping is “semi-chemical” in the sense that it also comprises mechanical refining of the pulp. Refining may for example be done using a disc refiner at digester pressure or at atmospheric pressure.

Currently, strength and mechanical properties of fluting and corrugating medium are improved by adding small amounts of chemical pulp to mechanical pulps. Typically, 5-15% chemical pulp is added. This of course adds costs but also leads to reduced dewatering speed. One potential route is to mix semi-chemical pulp such as NSSC with unbleached kraft pulp, although this may lead to undesired optical mottle and variations in shade, as well as variations in organoleptic properties.

The fluting and liner(s) are attached to each other by arranging an adhesive between the corrugated medium and liner(s). The liner is attached to at least one surface of the corrugated medium by the adhesive. The adhesive is preferably applied on a least one surface of the fluted corrugated medium and the liner is thereafter attached to said surface. Any conventional adhesives in the area may be used. The adhesive may for example be a glue that is based on starch that can be extracted from a wide variety of plants. Some of the most common plants are maize, wheat, barley, rice, potato, tapioca and peas. The starch is preferably native, i.e. no modification of the starch has been done. The adhesive may also comprise water, sodium hydroxide and boric acid. Other additives, such as additives to improve the wet strength or adhesive bond strength may also be added. Also, other functional chemicals in order to improve e.g. moisture resistance or gelling behavior can be added, e.g. borax, glyoxal or mixtures thereof.

One important challenge when making corrugated medium and corrugated board is the resistance to humidity. When the corrugated board is exposed to humidity, water and water vapor may diffuse through the liners and soften the corrugating medium. A common solution to this problem is to increase grammage of the fluting and/or liner, but this is in conflict with environmental demands requiring lower grammage materials consuming less raw material.

Another solution is to provide a barrier layer on the liner to reduce the penetration of water and water vapor. However, this is only a partial solution since moisture diffusion may still occur on the opposite side or via the edges and consequently impact the mechanical stability of the corrugated board. Barrier layers also increase cost and typically reduce recyclability of the materials.

The fluting or corrugating medium may also be treated with hydrophobizing chemicals or coated, but this generally adds costs and may also impact the mechanical properties of the fluting negatively. High levels of hydrophobizing chemicals may also compromise the adhesion between the fluting and the liner(s). Particularly, NSSC pulps require high levels of hydrophobizing chemicals to obtain a required level of water resistance in the finished fluting.

New machine concepts and increased machine speeds, combined with increased demands for source reduction, has further increased the need for pulps with improved properties.

There remains a need for new and improved fluting and liner materials that combine strength, low grammage, water/moisture resistance, low chemical consumption, low cost, and/or high recyclability.

### DESCRIPTION OF THE INVENTION

It is an object of the present disclosure to provide an improved containerboard, preferably for use in corrugated board, which solves or ameliorates at least some of the above mentioned problems.

It is a further object of the present disclosure to provide a containerboard with improved strength properties.

It is a further object of the present disclosure to provide a containerboard with more efficient use of strength and performance chemicals.

It is yet a further object of the present disclosure to provide a method for manufacturing a multiply containerboard, preferably for use in corrugated board with more efficient use of strength and performance chemicals and/or more efficient dewatering.

The above-mentioned objects, as well as other objects as will be realized by the skilled person in the light of the present disclosure, are achieved by the various aspects of the present disclosure.

The present invention is based on the inventive realization that a more efficient use of strength and performance chemicals as well as more efficient dewatering in the manufacture of NSSC based containerboard can be achieved if the strength and other performance chemicals are applied as a separate interfacial layer at the interface between two NSSC based plies. When mixing all chemicals in the NSSC 10 based furnish directly, before forming, the chemical retention is poor and fines distribution is difficult to control. A problem is also that high amounts of retention and strength chemicals are required. The addition of strength and other performance chemicals in an interfacial layer can improve the strength of the NSSC based containerboard and may also reduce the amount of chemicals required for obtaining required properties in the NSSC based containerboard, thereby reducing the cost of the containerboard. Applying the strength and other performance chemicals in an interfacial layer also allows for more rapid dewatering of the containerboard than when the chemicals are mixed with the NSSC pulp. Without being bound to any specific scientific theory, it is contemplated that placing the chemicals in an in an interfacial layer does not impede dewatering to the same extent as when the chemicals are provided mixed with the NSSC pulp. Furthermore, it was found that the strength of the containerboard was even further improved by also adding a strength enhancement agent to the outer plies of the containerboard. Consequently, the combination of an interfacial layer comprising high amount of strength enhancement agent and two outer plies, that also comprises a strength enhancement agent, was found to improve the strength, especially the compression strength, of the containerboard.

According to a first aspect illustrated herein, there is provided a multiply containerboard for use in corrugated board, said multiply containerboard comprising:
a first outer ply comprising a strength enhancement agent,
a second outer ply comprising a strength enhancement agent, and
an interfacial layer joining said first and second outer ply,
wherein each of said first and second outer ply comprise at least 50 wt % neutral sulfite semi chemical (NSSC) pulp based on dry weight, and
wherein said interfacial layer comprises a strength enhancement agent in an amount of 0.5-20 gsm wherein the amount of strength enhancement agent in the interfacial layer is higher, preferably at least twice as high as the concentration of the strength enhancement agent in each of the first and second outer ply.

The containerboard of the present disclosure is a multiply containerboard comprising at least 2 plies, a first outer ply (also referred to as the top ply) and a second outer ply (also referred to as the back ply). The outer plies are joined by an interfacial layer. The outer surfaces of the multiply containerboard, i.e. the surfaces of the top and back ply facing away from the interfacial layer, are referred to as top side and back side respectively.

Due to the high content of NSSC pulp, the containerboard of the present disclosure is particularly useful as corrugating medium or fluting to be used in corrugated board. Accordingly, in preferred embodiments, the containerboard is a fluting.

This being said, the containerboard of the present disclosure may also be used as liner in corrugated board for applications wherein the high content of NSSC pulp is acceptable.

Placing a higher amount of additives, including the strength enhancement agent in an interfacial layer rather than distributing the additives throughout the entire multiply containerboard, can provide better glue uptake in corrugator (due to higher starch uptake by the outer plies). Placing the additives in the intermediate ply rather than in the outer plies also allows for high amounts of additives to be used, which can lead to less mechano-sorptive creep in the finished corrugated board.

The containerboard of the present disclosure is a multiply containerboard comprising at least 2 plies joined by an interfacial layer. The containerboard can be manufactured in a paper or paperboard machine adapted for manufacturing of multiply containerboard. Paper or paperboard machines for making containerboard are well known in the art. Typically, the machine layout comprises a stock handling section, a wet end section, a pressing and drying section and optionally a calendaring and/or coating section. In the wet end section, the plies may be formed individually, using different headboxes and laminated in a wet state, or formed together in a multiply headbox. If formed individually, the plies are typically laminated before the press and drying section of the paper machine.

“NSSC pulp” is obtained from “NSSC pulping”, which in turn is defined in the background section. The NSSC pulp can be hardwood pulp or softwood pulp, or a mixture thereof. The NSSC pulp is preferably hardwood pulp or a hardwood/softwood pulp mixture with less than 15 wt % softwood, preferably less than 10 wt % softwood, and more preferably less than 5 wt % softwood. The hardwood may for example be aspen, alder, poplar, eucalyptus, birch, acacia, or beech. The NSSC pulp is preferably prepared cooked using a cooking liquor comprising sulfite, preferably Na₂SO₃ or (NH₄)₂SO₃ and a base, preferably NaOH or Na₂CO₃. In some embodiments the yield from the NSSC pulping is above 60%, preferably above 65%, preferably above 70%, and more preferably above 75%. The term “neutral” means that the pH of the NSSC cooking liquor is in the range of 6-10. The cooking time preferably in the range of 5 minutes to 3 hours. The cooking temperature is preferably in the range of 160-200° C. The NSSC pulp may comprise comparatively high amounts of residual lignin, such as 15-20%. The Kappa number of the NSSC pulp is typically above 70, preferably above 80, preferably above 95, and more preferably above 100, according to ISO 3260. The NSSC pulping is “semi-chemical” in the sense that it also comprises mechanical refining of the pulp. Refining may for example be done using a disc refiner at digester pressure or at atmospheric pressure. The refining can be done in one or more steps at the same or different pulp consistencies. A first refining step may preferably be done at higher consistency such as 5-35%, and a second refining step may preferably be done at lower consistency <5%.

In some embodiments, the NSSC pulp has a water retention value (WRV) in the range of 120-300%, preferably in the range of 120-270%. The WRV value may be determined by standard ISO 23714 with the use of a 100 mesh wire.

Each of the first and second outer ply comprise at least 50 wt % NSSC pulp based on dry weight. In some embodiments, each of said first and second outer ply comprise at least 60 wt %, preferably at least 70 wt %, NSSC pulp based on dry weight. The first and second outer ply may comprise 100 wt % NSSC pulp, but more commonly, the plies may also comprise other components, such that the first and second outer ply comprise 95 wt % or less, 90 wt % or less, 85 wt % or less, 80 wt % or less, or 75 wt % or less, NSSC pulp, based on dry weight.

The part of the first and second outer ply not being NSSC pulp may comprise any kind of fibers, such as hardwood and/or softwood fibers and may include, e.g., chemical pulp, mechanical pulp, thermomechanical pulp or chemi-thermomechanical pulp (CTMP). The part of the first and second outer ply not being NSSC pulp may also for example comprise recycled fibers. For example, the first and second outer ply of the present disclosure may consist essentially of NSSC pulp or a mixture of NSSC pulp and recycled fibers. “Recycled fibers” refers to fiber material that has previously been incorporated in some paper or board product. Alternatively, or as a complement, the part of the pulp not being NSSC pulp may for example comprise reject pulp. For example, the pulp of the present disclosure may consist essentially of NSSC pulp and reject pulp. “Reject pulp” refers to pulp prepared by refining the screen reject from a pulping process.

In some embodiments, each of said first and second outer ply further comprise at least 10 wt %, preferably at least 20 wt %, more preferably at least 30 wt %, unbleached kraft pulp based on dry weight. Unbleached kraft pulp, or UBKP generally refers to an unbleached sulphate pulp based on pine and/or spruce.

In some embodiments, the grammage of each of the first outer ply and the second outer ply is in the range of 20-120 g/m², preferably in the range of 30-80 g/m². The total grammage of the multiply containerboard is preferably in the range of 60-300 g/m².

In some embodiments, the first and second outer ply are formed from the same pulp suspension, or from pulp suspensions having identical composition. In some embodiments, the composition of the first and second outer ply is identical, or almost identical. In some embodiments, the composition and grammage of the first and second outer ply are identical, or almost identical. Having identical, or almost identical first and second outer plies reduces problems with deformation of the multiply containerboard when exposed to variations in humidity and temperature.

Due to the high content of NSSC pulp in the outer plies, the multiply containerboard overall has a high content of NSSC pulp. In some embodiments, said multiply containerboard comprises at least 50 wt %, preferably at least 60 wt %, of NSSC pulp based on dry weight. In some embodiments, the multiply containerboard comprises 50-95 wt %, preferably at least 60-95 wt %, of NSSC pulp based on dry weight.

In some embodiments, the NSSC pulp used in the multiply containerboard is a fractionated NSSC pulp. Fractionated NSSC pulp is obtained by size fractionation of an NSSC pulp starting material into a fine fiber fraction and a coarse fiber fraction. Compared to the starting material, the fine fiber fraction has a higher amount of shorter and thinner fibers. In other words, the average particle size of NSSC pulp of the fine fiber fraction is lower than the average particle size of the NSSC pulp of the coarse fiber fraction. The fine fiber fraction may for example be obtained by separating the NSSC pulp starting material in pressure screens to achieve a fraction with shorter and thinner fibers.

The fine fiber fraction obtained by size fractionation of an NSSC pulp is especially advantageous for use in the outer plies of the multiply containerboard, since it has less effect on the optical properties of the liner as compared to an unfractionated or coarse fiber fraction of the NSSC pulp.

The interfacial layer is preferably formed by applying an aqueous suspension comprising a strength enhancement agent between the first and second outer ply to obtain an interfacial layer between the first and second outer ply. Depending on the extent to which the aqueous suspension and the strength enhancement agent is absorbed into the first and second outer ply, the interfacial layer may either take the form of a separate ply, or it can more take the form of an interfacial zone with a high content of the strength enhancement agent at the interface between the two outer plies.

The first and second outer plies and the interfacial layer comprises at least one strength enhancement agent. The strength enhancement agent is preferably selected form the group consisting of a starch based strength enhancement agent, a cellulose based strength enhancement agent, and mixtures thereof.

In some embodiments, the strength enhancement agent is a starch based strength enhancement agent. The starch based strength enhancement agent may for example comprise cooked or gelatinzed or uncooked starch, or a mixture thereof.

Strength in fiber and paperboard products can be increased by enhancing fiber-fiber contact, such as by surface fibrillation. One possibility to increase the strength of a coarser fiber mixture is to add fine cellulosic material, such as cellulose fines, e.g. obtained from white water during web formation, highly refined cellulose, or microfibrillated cellulose (MFC) as a strength enhancing agent.

In some embodiments, the strength enhancement agent is a cellulose based strength enhancement agent. The cellulose based strength enhancement agent preferably comprises, or consists of, a fine cellulosic material such as highly refined cellulose. Refining, or beating, of cellulose pulps refers to mechanical treatment and modification of the cellulose fibers in order to provide them with desired properties.

In some embodiments, the cellulose based strength enhancement agent has a water retention (WRV) value of ≥250%, more preferably ≥300%. In addition, the WRV value is preferably ≤500%, more preferably ≤450% or ≤400% or ≤350%. In some embodiments, the cellulose based strength enhancement agent has a WRV value of 250-400%, or 250-380%, or 250-350%, or 300-350%. The WRV value may be determined by standard ISO 23714 with the use of a 200 mesh wire.

In some embodiments, the cellulose based strength enhancement agent has a Schopper-Riegler (SR) number above 70, and preferably in the range of 70-98, as determined by standard ISO 5267-1.

In some embodiments, the strength enhancement agent is selected from the group consisting of cellulose fines, highly refined cellulose having a Schopper Riegler number in the range of 70-90, microfibrillated cellulose (MFC), and mixtures thereof.

The term cellulose fines as used herein generally refers to cellulosic particles significantly smaller in size than cellulose fibers. In some embodiments, the term fines as used herein refers to fine cellulosic particles, which are able to pass through a 200 mesh screen (equivalent hole diameter 76 μm) of a conventional laboratory fractionation device (SCAN-CM 66:05). There are two major types of fiber fines, namely primary and secondary fines. Primary fines are generated during pulping and bleaching, where they are removed from the cell wall matrix by chemical and mechanical treatment. As a consequence of their origin (i.e., compound middle lamella, ray cells, parenchyma cells), primary fines exhibit a flake-like structure with only minor shares of fibrillar material. In contrast, secondary fines are generated during the refining of pulp.

The term highly refined cellulose pulp as used herein refers to a cellulose pulp which has been subjected to considerable refining, but not to the extent that all of the cellulose pulp will pass through a 200 mesh screen (equivalent hole diameter 76 μm) of a conventional laboratory fractionation device (SCAN-CM 66:05). The term highly refined cellulose pulp as used herein refers to a cellulose pulp having a Schopper-Riegler (SR) number above 70, and preferably in the range of 70-90, as determined by standard ISO 5267-1.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

In some embodiments, the strength enhancement agent comprises a mixture of a starch based strength enhancement agent and a cellulose based strength enhancement agent. In some embodiments, the ratio of the content of said starch based strength enhancement agent to the content of said cellulose based strength enhancement agent is in the range of from 0.1: 10 to 10: 0.1, more preferably in the range of from 0.1: 5 to 5: 0.1.

In some embodiments, the interfacial layer further comprises a crosslinker. The crosslinker may for example be citric acid. In some embodiments, the interfacial layer further comprises an insolubilizer. The insolubilizer may for example be an amino resin, glyoxal, or zirconium salt insolubilizer.

The interfacial layer is preferably comprised of the strength enhancement agent and optionally other performance chemicals, such as starch, retention/drainage agents, and internal sizing agents.

The interfacial layer may also comprise some cellulose fibers, i.e. cellulose in fibrous form, and not highly refined or microfibrillated cellulose. The interfacial layer preferably has a significantly lower content of cellulose fibers than the first and second outer plies. The interfacial layer preferably comprises less than 30 wt %, and more preferably less than 20 wt %, of cellulose fibers, based on dry weight. In some embodiments, the interfacial layer is free from, or almost free from cellulose fibers. In some embodiments, the interfacial layer comprises less than 2 wt %, preferably less than 0.5 wt %, of cellulose fibers, based on dry weight.

The grammage of the interfacial layer is significantly lower than the grammage of the first and second outer plies. In some embodiments, said interfacial layer has a grammage in the range of 0.5-20 gsm, preferably in the range of 1-10 gsm.

The interfacial layer preferably consists mainly of the strength enhancement agent. In some embodiments, said interfacial layer comprises at least 50 wt %, preferably at least 70 wt %, of said strength enhancement agent based on dry weight.

The interfacial layer comprises said strength enhancement agent at a grammage in the range of 0.5-20 gsm, preferably in the range of 1-10 gsm and even more preferred in the range of 1-7 gsm.

The first and/or second outer plies preferably comprises a strength enhancement agent in the amount of 2-50 kg/ton, preferably between 5-30 kg/ton based on dry weight. It is preferred to add a starch-based strength enhancement agent in an amount of 2-15 kg/ton, preferably between 4-10 kg/ton based on dry weight. It is preferred to add a cellulose based strength enhancement agent in an amount of 2-50 kg/ton, preferably between 5-40 kg/ton or even more preferred between 10-30 kg/ton based on dry weight.

The first and second outer plies may comprise the same kind of strength enhancement agent but it is also possible to use different strength enhancement agents in the two outer plies. It is possible to use the same amount of the strength enhancement agent in the first and second outer plies but it is also possible to add different amounts of strength enhancement agents to the two outer plies.

The amount of strength enhancement agent in the interfacial layer is higher in the interfacial layer than in the outer plies. In some embodiments, the amount of the strength enhancement agent is higher, preferably at least twice as high, in the interfacial layer than in each of the first and second outer ply. Preferably, the amount of strength enhancement agent in the interfacial layer is at least 4, 6, 8 or 10 times as high as the amount of the strength enhancement agent in each of the first and second outer ply. If the two outer plies comprise different amounts of strength enhancement agents, the interfacial layer comprises at least twice as high amounts as the outer ply with the highest amount of strength enhancement agent. The amount of strength enhancement agent in the interfacial layer is Having a higher amount of the strength enhancement agent in the interfacial layer and a lower amount in the outer plies provides for improved dewatering and better retention of the strength enhancement agent in the multiply containerboard. Also, it has been found that the compression strength of the containerboard is improved by addition of lower amount of strength enhancement agent in the outer plies and a higher amount of strength enhancement agent in the interfacial layer.

The interfacial layer may further comprise additives such as a filler, retention and/or drainage chemicals, flocculation additives, deflocculating additives, dry strength additives, softeners, cross-linking aids, sizing chemicals, dyes and colorants, wet strength resins, fixation agents, de-foaming aids, microbe and slime control aids, or mixtures thereof.

In some embodiments, said interfacial layer further comprises a retention/drainage agent at a concentration which is at least twice as high as the concentration of the retention/drainage agent in each of the first and second outer ply.

Placing the retention/drainage agent in the interfacial layer enables better formation but can also reduce the total amount of retention aid required.

In some embodiments, said interfacial layer further comprises an internal sizing agent. In some embodiments, the interfacial layer further comprises an internal sizing agent at a concentration which is at least twice as high as the concentration of the internal sizing agent in each the first and second outer ply.

The internal sizing agent is preferably a hydrophobizing sizing agent. In some embodiments, the internal sizing agent is selected form the group consisting of alkyl ketene dimer (AKD), alkenyl succinic anhydride (ASA), rosin sizes, and mixtures thereof.

In some embodiments, the amount of the internal sizing agent in the multiply containerboard is in the range of 0.5-5 kg/tn.

In some embodiments, the ratio of the content of said internal sizing agent to the content of said strength enhancement agent is in the range of from 0.1: 10 to 10: 0.1, more preferably in the range of from 0.1: 5 to 5: 0.1.

It has been found that the multiply containerboard benefits from not being over-dried. Particularly, it has been found that better fracture toughness of the multiply containerboard is obtained when it is dried to a specific moisture content. In some embodiments, the moisture content of the multiply containerboard is in the range of 3-17 wt %, preferably in the range of 4-14 wt %, and more preferably in the range of 5-15 wt %.

In some embodiments, the multiply containerboard has a fracture toughness Index GEOM (ISO/TS 17958) higher than 6 Jm/kg, preferably higher than 7 Jm/kg, and more preferably higher than 8 Jm/kg.

In some embodiments, the multiply containerboard has a SCT Index GEOM (ISO 9895) higher than 23 Nm/g, preferably higher than 24 Nm/g, and more preferably higher than 25 Nm/g.

In some embodiments, at least one of the outer plies of the multiply containerboard is optimized to provide a good printing surface and good moisture resistance. In some embodiments, at least an outer ply intended as the outer surface of a corrugated board is optimized to provide a good printing surface and good moisture resistance. In some embodiments, the optimization to provide a good printing surface and good moisture resistance includes surface sizing. In some embodiments the multiply containerboard is surface sized. In some embodiments the multiply containerboard is surface sized with starch. In some embodiments the multiply containerboard is surface sized with a combination of starch and at least one other functional component, preferably selected from the group consisting of a crosslinker, a reinforcing agent, and a hydrophobizing sizing agent. The crosslinker may for example be citric acid. The reinforcing agent may for example be microfibrillated cellulose (MFC). The hydrophobizing sizing agent may for example be alkyl ketene dimer (AKD), alkenyl succinic anhydride (ASA), SMA (Styrene Maleic Anhydride), a rosin size, or mixtures thereof.

Corrugated board comprises at least one layer of liner, which is non-corrugated, and at least one layer of fluting. In normal production of corrugated board, fluting is corrugated and then glued to linerboard. For example, corrugated board may consist of a layer of fluting sandwiched between two layers of liner.

According to a second aspect illustrated herein, there is provided a corrugated board comprising a multiply containerboard as defined with reference to the first aspect as fluting and/or liner.

The multiply containerboard for use in corrugated board can be manufactured by a method comprising the steps of:
a) forming a first web layer from a first pulp suspension comprising a strength enhancement agent and dewatering said first web layer to obtain a first outer ply;
b) applying an aqueous suspension comprising a strength enhancement agent to obtain an interfacial layer on the first outer ply;
c) forming a second web layer from a second pulp suspension comprising a strength enhancement agent and dewatering said second web layer to obtain a second outer ply on the interfacial layer;
wherein each of said first and second pulp suspension comprise at least 50 wt % neutral sulfite semi chemical (NSSC) pulp based on dry weight, and
wherein said aqueous suspension comprises a strength enhancement agent in an amount of 0.5-20 gsm wherein the amount of strength enhancement agent in the interfacial layer is higher, preferably at least twice as high as the concentration of the strength enhancement agent in the first and second pulp suspension.

The terms first and second web layer do not necessarily denote the order in which the web layers are formed. The web layers can be formed simultaneously or individually, in any order.

In some embodiments, the first and second web layer are formed and partially dewatered individually, using different headboxes and one or more wires, and subsequently laminated in a wet state. The interfacial layer is applied before the first and second web layers are laminated.

In some embodiments, the first web layer, the interfacial layer, and the second web layer, are formed and partially dewatered together using a multiply headbox and a single wire.

In some embodiments, each of said first and second pulp suspension comprise at least 60 wt %, preferably at least 70 wt %, NSSC pulp based on dry weight.

In some embodiments, each of said first and second pulp suspension further comprise at least 10 wt %, preferably at least 20 wt %, more preferably at least 30 wt %, unbleached kraft pulp based on dry weight.

In some embodiments, the grammage of each of the first outer ply and the second outer ply is in the range of 20-100 g/m², preferably in the range of 30-80 g/m².

In some embodiments, the composition of the first and second pulp suspension is identical. In some embodiments, the composition and grammage of the first and second outer ply is identical, or almost identical.

In some embodiments, said aqueous suspension comprises less than 2 wt %, preferably less than 0.5 wt %, of cellulose fibers, based on dry weight.

In some embodiments, said aqueous suspension is applied as an intermediate layer using a multilayer headbox.

The method comprises forming and dewatering a number of webs from pulp suspensions. Methods for forming and dewatering webs having multiple layers are well known in the art. The containerboard can be manufactured in a paper or paperboard machine adapted for manufacturing of multiply containerboard. Paper or paperboard machines for making multiply containerboard are well known in the art. Typically, the machine layout comprises a stock handling section, a wet end section, a pressing and drying section and a calendering and/or coating section.

The webs are generally formed and dewatered in a formed in a wet end section, comprising one or more wires as conventional in the field. The outer plies may be formed and partially dewatered individually, using different headboxes and laminated in a wet state, or formed together in a multiply headbox. The web is typically formed in a gap former, but it may also be formed in a fourdrinier type former. If formed individually, the wet plies are typically laminated, or couched together, before the press and drying section of the paper machine.

The aqueous suspension comprising a strength enhancement agent is applied between the first and second outer ply. In some embodiments, the aqueous suspension is formed as a separate water layer between the first and second outer ply using a multiply headbox. The aqueous suspension may also be added between the first and second outer ply using a non-contact deposition technique, such as spray or foam or curtain coating application before the plies are laminated or couched together. Preferably, the solid content of the aqueous dispersion is in the range of 0.5-50 wt %, and more preferably in the range of 1-30 wt %.

The web is typically subjected to further dewatering, which may for example include passing the formed multilayer web through a press section of the paper machine, where the web passes between large rolls loaded under high pressure to squeeze out as much water as possible. The press section may constitute of traditional nip press units and press fabric felts and/or with one or several shoe presses or extended dewatering nips. These can be run at various nip or press loads including different positions, temperatures and delays times. The press section may be provided with one or more shoe presses to maximize production. If using one or several shoe presses, these can be run at press levels above 800 kN/m, such as above 1000 kN/m, such as above 1200 kN/m, or such as such as above 1450 kN/m. The removed water is typically received by a fabric or felt.

After the press section, the multilayer web may be subjected to drying in a drying section. The drying may for example include drying the multilayer web by passing the multilayer web around a series of heated drying cylinders. Drying may typically remove the water content down to a level of about 1-15 wt %. However, it has been found that the multiply containerboard benefits from not being over-dried. Particularly, it has been found that better fracture toughness of the multiply containerboard is obtained when it is dried to a specific moisture content. In some embodiments, the moisture content of the multiply containerboard is in the range of 3-17 wt %, preferably in the range of 4-14 wt %, and more preferably in the range of 5-15 wt %.

The web may further be conditioned with heat and steam and fed between large corrugating rolls to give the finished fluting its corrugated shape.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

The examples demonstrate that high amounts of NSSC pulp in the outer plies combined with an interfacial layer comprising a strength enhancement agent can be used to provide multiply containerboard with good mechanical properties.

### Multiply Containerboard Preparation Method

Multiply containerboard comprising a front ply (corresponding to the first outer ply of the invention), and a back ply (corresponding to the second outer ply of the invention) and an interfacial layer comprising starch as a strength enhancement agent were prepared on a pilot machine equipped with 3 headboxes and 3 wires, a press section, and a drying section. The target end moisture content for the 3 ply structures was 8.5 wt % and the target grammage was 120 g/m². The web was calendered online with a machine calender at 100° C. and a nip load of 45 KN/m.

The NSSC pulp, had a Lc(w) fiber length of 1.14 mm as determined by the FS5 ISO method. The FS5 curl was 2% and FS5 fibrillation 1.55%. The FS5 Fines A amount was 20.3%.

The unbleached kraft pulp (UBKP) was refined to SR 30. The corresponding fiber properties were: Lc(w) fiber length of 2.32 mm, FS5 curl of 6.8% and FS5 fibrillation 1.78%. The FS5 Fines A amount was 18.8%.

All pulp suspensions contained the same amounts of retention and drainage chemicals and strength and internal sizing chemicals (AKD).

The pH of the pulp suspensions was about 7.0 (+0.5).

When starch was applied between the outer plies, the applied amount was about 2 g/m², based on dry weight. Starch was applied by spraying an aqueous suspension comprising the starch onto the back ply before the plies were couched together before the press section.

### Example 1 (Comparative Example)

A 120 g/m² 1-ply containerboard was prepared as set out in Table 1 according to the multiply containerboard preparation method from a pulp suspension comprising 92.5% NSSC pulp and 7.5% UBKP.

The obtained multiply containerboard was analyzed and the results are presented in Table 2.

### Example 2 a and 2B

The pulp suspension of Example 1 was split into two different batches and run in a multilayer wet forming mode using two headboxes and two wires as set out in Table 1. The webs were couched together before the press section. In sample 2A, 2 g/m² starch was applied between the two webs, whereas in sample 2B no starch was applied.

The obtained multiply containerboards were analyzed and the results are presented in Table 2.

### Example 3A and 3B

A corresponding multilayer structure as made in Example 2 was made but with a 50-50 pulp mixture of NSSC and UBKP in the top ply and a 95-5 pulp mixture of NSSC and UBKP in the back ply as set out in Table 1. In sample 3A, 2 g/m² starch was applied between the two webs, whereas in sample 3B no starch was applied.

The obtained multiply containerboards were analyzed and the results are presented in Table 2.

### Example 4A and 4B (Comparative)

A corresponding multilayer structure as made in Example 2 was made, but with 100% UBKP in both top and back ply as set out in Table 1. In sample 4A, 2 g/m² starch was applied between the two webs, whereas in sample 4B no starch was applied.

The obtained multiply containerboards were analyzed and the results are presented in Table 2.

TABLE 1

| | | 1 | 2A | 2B | 3A | 3B | 4A | 4B |
|---|---|---|---|---|---|---|---|---|
| | Unit | 1-ply | 2-ply | 2-ply | 2-ply | 2-ply | 2-ply | 2-ply |
| Grammage. total | g/m² | 120 | 120 | 120 | 120 | 120 | 120 | 120 |
| Grammage. top-ply | g/m² | 120 | 60 | 60 | 40 | 40 | 40 | 40 |
| Grammade. back-ply | g/m² | | 60 | 60 | 80 | 80 | 80 | 80 |
| Pulp Composition top-ply | | | | | | | | |
| UBKP | | 7.5 | 7.5 | 7.5 | 50 | 50 | 100 | 100 |
| NSSC | | 92.5 | 92.5 | 92.5 | 50 | 50 | | |
| Pulp Composition back-ply | | | | | | | | |
| UBKP | | | 7.5 | 7.5 | 5 | 5 | 100 | 100 |
| NSSC | | | 92.5 | 92.5 | 95 | 95 | | |
| Spray starch | g/m² | 0.0 | 2.0 | 0.0 | 2 | 0 | 2 | 0 |

TABLE 2

| | Unit | 1 | 2A | 2B | 3A | 3B | 4A | 4B |
|---|---|---|---|---|---|---|---|---|
| Brightness C/2° + UV, ts | % | 38.42 | 36.12 | 36.39 | 23.6 | 24.21 | 15.56 | 15.36 |
| Brightness C/2° + UV, bs | % | 38.94 | 38.2 | 37.88 | 38.78 | 39.31 | 15.9 | 15.66 |
| L* C/2° + UV, ts | | 79.17 | 77.91 | 78.03 | 69.83 | 70.27 | 59.3 | 58.94 |
| L* C/2° + UV, bs | | 79.46 | 78.75 | 78.59 | 78.61 | 78.93 | 59.3 | 58.95 |
| a* C/2° + UV, ts | | 2.74 | 3.08 | 3 | 6.11 | 5.99 | 7.61 | 7.64 |
| a* C/2° + UV, bs | | 2.65 | 2.87 | 2.91 | 2.3 | 2.2 | 7.44 | 7.49 |
| b* C/2° + UV, ts | | 19.2 | 20.01 | 19.86 | 24.96 | 24.66 | 22.74 | 22.6 |
| b* C/2° + UV, bs | | 19.04 | 18.75 | 18.88 | 17.77 | 17.67 | 21.98 | 21.9 |
| Grammage | g/m² | 120.1 | 125.6 | 121.5 | 121.7 | 120 | 123 | 124.2 |
| Thickness, single sheet | μm | 181 | 170 | 168 | 182 | 177 | 169 | 169 |
| Density, single sheet | kg/m³ | 665 | 738 | 725 | 669 | 678 | 726 | 734 |
| Bulk, single sheet | cm³/g | 1.5 | 1.35 | 1.38 | 1.49 | 1.47 | 1.38 | 1.36 |
| Grammage top layer | g/m² | | | 47 | | | | 38.9 |
| Grammage bottom layer | g/m² | | | 77.1 | | | | 89.6 |
| Grammage, total | | | | 124.1 | | | | 128.5 |
| Air permeability G-H | μm/Pas | 3.821 | 2.832 | 3.563 | 2.769 | 4.01 | 1.226 | 1.359 |
| Air resistance G-H | s/100 ml | 33.5 | 45.2 | 35.92 | 46.22 | 31.92 | 104.4 | 94.22 |
| Bendtsen roughness, ts | ml/min | 842 | 582 | 576 | 648 | 922 | 779 | 696 |
| Bendtsen roughness, bs | ml/min | 1769 | 905 | 1060 | 1332 | 1363 | 1353 | 1324 |
| Moisture content 50% rh | % | 7.16 | 7.16 | 7.01 | 7.21 | 7.11 | 7.88 | 7.83 |
| Scott-Bond, md | J/m² | 440 | 543 | 328 | 510 | 297 | 479 | 396 |
| Tensile strength, md | kN/m | 9.58 | 12.5 | 11.64 | 11.98 | 11.78 | 13.2 | 12.92 |
| Tensile strength, cd | kN/m | 5.84 | 6.33 | 5.73 | 5.83 | 5.73 | 5.85 | 5.8 |
| Tensile index, md | Nm/g | 79.78 | 99.46 | 95.79 | 98.45 | 98.12 | 107.28 | 104.01 |
| Tensile index, cd | Nm/g | 48.61 | 50.41 | 47.15 | 47.94 | 47.75 | 47.54 | 46.67 |
| Tensile index geom. | | 62.3 | 70.8 | 67.205 | 68.7 | 68.4 | 71.4 | 69.7 |
| Tensile strength md/cd | | 1.64 | 1.97 | 2.03 | 2.05 | 2.05 | 2.26 | 2.23 |
| Stretch, md | % | 1.6 | 1.7 | 1.6 | 1.6 | 1.6 | 2.1 | 2 |
| Stretch, cd | % | 3.6 | 4.4 | 4.2 | 4.7 | 4.6 | 6.8 | 6.9 |
| Tensile stiffness, md | kN/m | 1064 | 1290.3 | 1248.4 | 1257.1 | 1259.4 | 1292.6 | 1302 |
| Tensile stiffness, cd | kN/m | 570.2 | 570.6 | 541.8 | 530.4 | 530.8 | 485.3 | 478.8 |
| Tensile stiffness index, md | kNm/g | 8.86 | 10.27 | 10.28 | 10.33 | 10.49 | 10.51 | 10.48 |
| Tensile stiffness index, cd | kNm/g | 4.75 | 4.54 | 4.46 | 4.36 | 4.42 | 3.95 | 3.86 |
| Tensile stiffness GM | kN/m | 778.88 | 858.03 | 822.42 | 816.59 | 817.6 | 792.03 | 789.58 |
| E-modulus, md | MPa | 5892 | 7581 | 7451 | 6912 | 7117 | 7630 | 7698 |
| E-modulus, cd | MPa | 3157 | 3353 | 3234 | 2917 | 2999 | 2865 | 2831 |
| TEA, md | J/m² | 94.14 | 126.83 | 111.64 | 120.08 | 114.46 | 174.7 | 164.37 |
| TEA, cd | J/m² | 151.12 | 198.85 | 172.35 | 195.84 | 188.27 | 284.53 | 289.79 |
| TEA index, md | J/g | 0.784 | 1.009 | 0.919 | 0.987 | 0.954 | 1.42 | 1.323 |
| TEA index, cd | J/g | 1.258 | 1.583 | 1.419 | 1.609 | 1.568 | 2.313 | 2.333 |
| TEA index geom. | | 0.99 | 1.26 | 1.142 | 1.26 | 1.22 | 1.81 | 1.76 |
| Fracture toughness, md | J/m | 0.758 | 0.879 | 0.91 | 1.04 | 1.017 | 2.027 | 2.14 |
| Fracture toughness, cd | J/m | 0.885 | 1 | 0.996 | 1.05 | 1.033 | 2.011 | 1.807 |
| Fracture toughness index, md | Jm/kg | 6.31 | 7 | 7.49 | 8.55 | 8.47 | 16.48 | 17.23 |
| Fracture toughness index, cd | Jm/kg | 7.37 | 7.96 | 8.2 | 8.63 | 8.61 | 16.35 | 14.55 |
| Fracture toughness index, | | 6.82 | 7.46 | 7.84 | 8.59 | 8.54 | 16.41 | 15.83 |
| Geom | | | | | | | | |
| Tearing resistance, md | mN | 683 | 663 | 616 | 719 | 732 | 1250 | 1256 |
| Tearing resistance, cd | mN | 649 | 796 | 747 | 859 | 850 | 1473 | 1544 |
| Tear index, md | mNm²/g | 5.7 | 5.3 | 5.1 | 5.9 | 6.1 | 10.2 | 10.1 |
| Tear index, cd | mNm²/g | 5.4 | 6.3 | 6.1 | 7.1 | 7.1 | 12 | 12.4 |
| SCT, md | kN/m | 4.26 | 5.25 | 5.04 | 4.75 | 4.67 | 4.55 | 4.93 |
| SCT, index md | | 35.5 | 41.8 | 41.5 | 39.0 | 38.9 | 37.0 | 39.7 |
| SCT, cd | kN/m | 3.14 | 3.33 | 3.08 | 2.99 | 2.92 | 2.76 | 2.59 |
| SCT, index cd | | 26.1 | 26.5 | 25.3 | 24.6 | 24.3 | 22.4 | 20.9 |
| SCT, GM | kN/m | 3.66 | 4.18 | 3.94 | 3.77 | 3.7 | 3.54 | 3.57 |
| SCT geom index | | 28.2 | 29.7 | 28.7 | 27.6 | 27.4 | 25.4 | 24.5 |
| RCT, md | N | 258.75 | 302.87 | 276.52 | 259.56 | 256.14 | 246.63 | 253.71 |
| RCT, cd | N | 217.69 | 260.33 | 225.24 | 212.07 | 210.01 | 187.1 | 193.78 |
| RCT KN/m, md | kN/m | 1.7 | 1.99 | 1.81 | 1.7 | 1.68 | 1.62 | 1.66 |
| RCT KN/m, cd | kN/m | 1.43 | 1.71 | 1.48 | 1.39 | 1.38 | 1.23 | 1.27 |
| RCT index, md | kNm/g | 0.0142 | 0.0158 | 0.0149 | 0.014 | 0.014 | 0.0132 | 0.0134 |
| RCT index, md | Nm/g | 14.15 | 15.84 | 14.90 | 13.97 | 14.00 | 13.17 | 13.37 |
| RCT index, cd | kNm/g | 0.0119 | 0.0136 | 0.0122 | 0.0114 | 0.0115 | 0.01 | 0.0102 |
| RCT index, cd | Nm/g | 11.91 | 13.61 | 12.18 | 11.42 | 11.50 | 10.00 | 10.23 |
| RCT index geom. | | 0.4 | 0.4 | 0.4 | 0.4 | 0.4 | 0.3 | 0.3 |
| IGT-picking, md ts | m/s | 1.11 | 1.18 | | 1.51 | | 1.66 | |
| Friction static ts/metal, md | | 0.247 | 0.256 | 0.262 | 0.235 | 0.229 | 0.255 | 0.244 |
| Friction kinetic ts/metal, md | | 0.242 | 0.253 | 0.251 | 0.233 | 0.215 | 0.224 | 0.216 |
| Burst index | kPam²/g | 2.75 | 3.41 | 3.34 | 3.61 | 3.27 | 4.16 | 3.94 |
| Bursting strength | kPa | 331 | 429 | 405 | 439 | 393 | 512 | 489 |

Unless otherwise stated, the physical properties discussed in the present disclosure are determined according to the following standards:

| | |
|---|---|
| Brightness C/2° + UV | ISO 2470-1 |
| L* C/2° + UV | ISO 5631-1 |
| a* C/2° + UV | ISO 5631-1 |
| b* C/2° + UV | ISO 5631-1 |
| Grammage | ISO 536 |
| Thickness, single sheet | ISO 534 |
| Bulk, single sheet | ISO 534 |
| Air permeability G-H | ISO 5636-5 |
| Cobb 30 s | ISO 535 |
| Moisture content 50% rh | ISO 287 |
| Scott-Bond | TAPPI T569 |
| Tensile strength | ISO 1924-3 |
| Tensile index | ISO 1924-3 |
| Tensile strength md/cd | ISO 1924-3 |
| Stretch | ISO 1924-3 |
| Tensile stiffness | ISO 1924-3 |
| Tensile stiffness index | ISO 1924-3 |
| E-modulus | ISO 1924-3 |
| TEA | ISO 1924-3 |
| TEA index | ISO 1924-3 |
| TEA index | ISO 1924-3 |
| Fracture toughness | ISO/TS 17958 |
| Fracture toughness index | ISO/TS 17958 |
| Tearing resistance | ISO 1974 |
| Tear index | ISO 1974 |
| SCT | ISO 9895 |
| SCT index | ISO 9895 |
| RCT | ISO 12192 |
| RCT index | ISO 12192 |
| Burst index | ISO 2759 |
| Bursting strength | ISO 2759 |

Unless otherwise stated, then the standard method can be applied for determining physical and mechanical properties in both cross direction (cd) and machine direction (md)

1. A multiply containerboard for use in corrugated board, said multiply containerboard comprising:
a first outer ply comprising a strength enhancement agent,
a second outer ply comprising a strength enhancement agent, and
an interfacial layer joining said first outer ply and the second outer ply,
wherein each of said first and second outer ply comprise at least 50 wt % neutral sulfite semi chemical (NSSC) pulp based on a dry weight, and
wherein said interfacial layer comprises a strength enhancement agent in an amount of 0.5-20 gsm, wherein the amount of strength enhancement agent in the interfacial layer is higher than a concentration of the strength enhancement agent in the first outer ply and a concentration of the strength enhancement agent in the second outer ply.

2. The multiply containerboard according to claim 1, wherein each of said first and second outer ply comprise at least 60 wt % NSSC pulp based on the dry weight.

3. The multiply containerboard according to claim 1, wherein each of said first and second outer ply further comprise at least 10 wt % unbleached kraft pulp based on the dry weight.

4. The multiply containerboard according to claim 1, wherein a grammage of each of the first outer ply and the second outer ply is in a range of 20-120 g/m².

5. The multiply containerboard according to claim 1, wherein the first outer ply and the second outer ply are formed from pulp suspensions having identical compositions.

6. The multiply containerboard according to claim 1, wherein said interfacial layer has a grammage in a range of 0.5-20 gsm.

7. The multiply containerboard according to claim 1, wherein said interfacial layer comprises at least 50 wt % of said strength enhancement agent based on the dry weight.

8. The multiply containerboard according to claim 1, wherein said interfacial layer comprises said strength enhancement agent at a grammage in a range of 1-10 gsm.

9. The multiply containerboard according to claim 1, wherein said strength enhancement agent is selected from a group consisting of: a starch based strength enhancement agent, a cellulose based strength enhancement agent, and mixtures thereof.

10. The multiply containerboard according to claim 1, wherein said strength enhancement agent is a cellulose based strength enhancement agent selected from a group consisting of: cellulose fines, highly refined cellulose having a Schopper Riegler number in the range of 70-90, and microfibrillated cellulose (MFC).

11. The multiply containerboard according to claim 1, wherein said interfacial layer further comprises a retention/drainage agent at a concentration which is at least twice as high as a concentration of a retention/drainage agent in each of the first and second outer plies.

12. The multiply containerboard according to claim 1, wherein said interfacial layer further comprises an internal sizing agent at a concentration which is at least twice as high as a concentration of an internal sizing agent in each of the first and second outer plies.

13. The multiply containerboard according to claim 1, wherein the strength enhancement agent in each of the first and second outer plies is in an amount between 2-50 kg/ton.

14. A corrugated board comprising:
the multiply containerboard as a fluting and/or a liner.

15. The corrugated board according to claim 14, wherein the multiply containerboard is the fluting.

16. The multiply containerboard according to claim 1, wherein the amount of the strength enhancement agent in the interfacial layer is at least twice as high as the concentration of the strength enhancement agent in the first outer ply and the concentration of the strength enhancement agent in the second outer ply.
